(19) United States
(12) Patent Application Publication
(10) Pub. No.: US 2015/0063919 A1
(43) Pub. Date: Mar. 5, 2015

(54) METHODS AND APPARATUS FOR ARRESTING FAILURES IN SUBMERGED PIPELINES

(71) Applicant: Halliburton Energy Services, Inc., Houston, TX (US)

(72) Inventors: Aimee Kathleen Greening, Duncan, OK (US); Steven Ray Lovett, Marlow, OK (US); Matthew Todd Howell, Duncan, OK (US)

(73) Assignee: Halliburton Energy Services, Inc., Houston, TX (US)

(21) Appl. No.: 14/015,368

(22) Filed: Aug. 30, 2013

(51) Int. Cl. F16L 1/26

(52) U.S. Cl. CPC F16L 1/26
USPC 405/184.1

(57) ABSTRACT

A packer apparatus is configured to be arranged within and arrest a failure of a submerged pipeline. In one example, the packer apparatus includes first and second mandrels coupled in selectively axial moveable relation to one another, and an elastomeric expansion boot circumferentially disposed around a portion of the second mandrel. The first mandrel is responsive to fluid flow in the pipeline to move axially toward the second mandrel from a first position to a second position. In the second position, the expansion boot is compressed axially between the first and second mandrels and expanded radially into engagement with an inner surface of the pipeline.

### BACKGROUND

This disclosure relates generally to offshore pipelines, and more specifically to methods and apparatus for responding to failures in offshore submerged pipelines.

In offshore pipeline installations, as the pipeline is laid on the sea floor the pipeline is subjected to significant forces and moments that can compromise the integrity of the pipeline and, in some cases, cause failures. In the event the submerged pipeline is compromised to the point of failure, water rushes into the pipeline. Such failures are commonly referred to as wet buckles. Once a wet buckle occurs the flooded pipeline is too heavy to retrieve for repair and re-installation.

Companies that lay the pipeline keep a fleet of compressor ships on standby while the pipeline is being laid on the sea floor in case of a failure like a wet buckle. The compressor ships are present to pump the water out of the pipeline to facilitate repair of the buckled section, by allowing the pipeline to be pulled back to the surface, to the pipelay vessel, for removal of the damaged section. After the water has been removed, sections of the damaged pipeline can be retrieved and brought to the surface and the pipelay vessel can continue laying pipe onto the sea floor.

Pipeline failures like wet buckles are relatively rare. As such, during installation, the fleet of compressor ships hired by the pipeline installation company is generally inactive and serves no function for the installation process unless the rare failure occurs. The cost of the compressor ships and the associated service the ships and crew provide can reach the millions of dollars.

### BRIEF DESCRIPTION OF DRAWINGS

FIG. 1 schematically depicts a submerged pipeline installation system including wet buckle packers in accordance with this disclosure.

FIG. 2 depicts an elevation view of an example wet buckle packer.

FIG. 3 depicts an exploded view of different components of the packer of FIG. 2.

FIG. 4A depicts a section view of the example packer of FIG. 2 in an unengaged state within a pipeline.

FIG. 4B depicts a section view of the example packer of FIG. 2 in an engaged state within a pipeline.

FIG. 5 depicts a detail view of a locking mechanism of the example packer of FIG. 2.

FIG. 6 depicts an example method of arresting a failure in a submerged pipeline.

### DETAILED DESCRIPTION

In view of the foregoing costs and other inefficiencies associated with recovering from an offshore pipeline failure, examples according to this disclosure are directed to methods and apparatus for automatically responding to water invasion into the inner diameter of pipe in an offshore pipeline and rapidly deploying a sealing system that will prevent or inhibit the laid pipeline from being flooded with water.

A packer apparatus in accordance with this disclosure is configured to be arranged within and arrest a failure of a submerged pipeline. In one example, the packer apparatus includes first and second mandrels coupled in selectively axial moveable relation to one another, and an elastomeric expansion boot circumferentially disposed around a portion of the second mandrel. The first mandrel is responsive to fluid flow in the pipeline to move axially toward the second mandrel from a first position to a second position. In the second position, the expansion boot is compressed axially between the first and second mandrels and expanded radially into engagement with an inner surface of the pipeline.

In the following examples, the apparatus for arresting pipeline wet buckles (and other pipeline failures) is referred to as a wet buckle packer. However, the apparatus could also be referred to as a plug, a shutoff pig, a baffle, or other terms connoting a device that restricts, and ideally prevents fluid flow through an annular pipeline.

Wet buckle packers in accordance with this disclosure provide a number of functions once actuated. Packer apparatus in accordance with this disclosure are sometimes referred to as configured to arrest a failure like a wet buckle in a submerged pipeline. Arresting a failure in a pipeline includes a number of different functions. In both dry and wet buckles, for example, the pipeline failure can include a structural failure including a buckle that causes the pipeline to at least partially collapse on itself. The structural buckle can run along the length of the pipeline unless it is arrested. In wet buckles, water also invades the inner diameter of the pipe causing the pipeline to become flooded. Packer apparatus in accordance with this disclosure can function to arrest both a structural buckle in a submerged pipeline, whether from a dry or wet buckle, and deploy a sealing system that will prevent or inhibit the laid pipeline from being flooded with water in the event of a wet buckle. The packer seals the inner diameter of the pipeline to prevent or significantly inhibit water from flooding the submerged pipeline. Additionally, the packer deploys a braking mechanism to prevent or inhibit the packer from moving within the pipeline under the significant pressures introduced by the sea (or fresh) water entering the pipe from the wet buckle.

As noted above, wet buckle packers in accordance with this disclosure are configured to be automatically actuated to seal the pipeline inner diameter from ingress of water. The mechanisms for sealing and braking employed in a wet buckle packer can be actuated in a variety of ways. For example, electrical, hydraulic, or pneumatic supply lines can be run from the pipelay vessel on the surface to the packer. However, deploying supply lines from the surface downpipe to the packer will add cost and complexity to the system. The wet buckle packer could also include a power source, e.g., a battery that could be used to actuate the seal and brake mechanisms. However, the inclusion of a battery or other power source to actuate the packer will add cost and complexity to the device. In some cases, therefore, wet buckle packers are believed to be better configured to automatically actuate without the use of a power source or external actuation generator like a supply line run downpipe from the surface. As a result, while power sources or external actuation may be used in association with wet buckle packers as described herein, the examples of this disclosure are in accordance with what is believed to be the better configuration, where no such power or external source is necessary for actuation.

Wet buckle packers in accordance with this disclosure provide a new approach to seal and anchor a packer-type plug in place within a pipeline in the event of a wet buckle. The packers are designed to provide increased durability and to include component parts that protect against external variances. Example wet buckle packers can provide a number of advantages including, e.g., removing the high cost of air compressor standby in submerged pipeline installations and providing a simple and cost effective device for arresting failures in the pipeline.

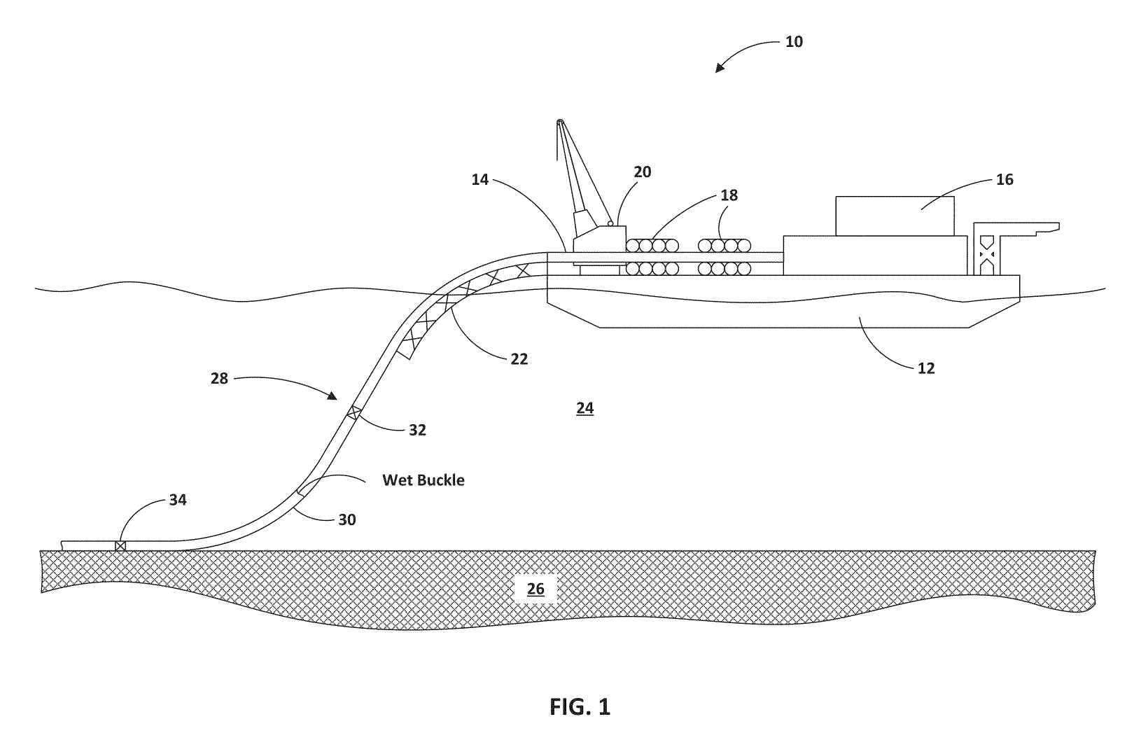

FIG. 1 depicts a submerged pipeline installation system 10. Offshore submerged pipelines can be installed in a number of ways. In general, individual pipes are transported by a cargo ship to a pipelay vessel at the pipeline installation location. The individual pipes are processed and connected to one another on the pipelay vessel and laid onto the sea floor. The pipelay vessel progressively welds individual pipes or welded pipe sections to one another to assemble the pipeline. As the pipeline is assembled the pipelay vessel moves across the surface of the water and the assembled pipeline is pulled off of the ship by the weight of the pipeline. As the pipeline is progressively pulled off of the back of the pipelay vessel it descends to the sea floor.

Two methods that are employed to install submerged pipelines are the “J” lay and the “S” lay. The moniker of each method represents the shape of the pipeline as it is pulled off of the pipelay vessel onto the sea floor. In a “J” lay, the pipeline is pulled off of the pipelay vessel substantially vertically to near the sea floor, where the pipeline bends to run horizontally along the floor. In an “S” lay, the pipeline is pulled off of the pipelay vessel substantially horizontally, bends vertically down toward the sea floor and then bends back horizontally away from the vessel to run along the sea floor. Although the following examples are described in the context of an “S” lay installation, wet buckle packers in accordance with this disclosure can also be employed in a “J” lay installation system or other pipeline installation methods not covered here.

FIG. 1 depicts a submerged pipeline installation system 10 for an “S” lay installation. In FIG. 1, system 10 includes pipelay vessel 12 and pipeline 14. Pipelay vessel 12 includes production factory 16, tensioners 18, crane 20, and stinger 22. As described in more detail below, after individual pipes are transported to and loaded on pipelay vessel 12, the pipes are conveyed into production factory 16. Production factory 16 includes a variety of processing stations for preparing pipes and coupling individual pipes into pipe sections and ultimately assembling pipeline 14, as will be known to persons skilled in the art.

Pipelay vessel 12 is shown floating in a body of water 24. Pipelay vessel 12 utilizes crane 20 to perform heavy lifting operations, including loading pipes from a cargo ship onto the vessel. In general, individual pipes on board pipelay vessel 12 are placed on an assembly line within production factory 16 and joints of the pipes are welded into pipeline 14. Pipeline 14 is held in tension between sea floor 26 and pipelay vessel 12 by pipeline tensioners 18 as the pipeline is lowered. As pipelay vessel 12 moves forward by pulling on a mooring system off of the bow, pipeline 14 is lowered from pipelay vessel 12 over stinger 22. Stinger 22 is attached to and extends from the stern of pipelay vessel 12, and provides support for pipeline 14 as it leaves pipelay vessel 12.

In practice, a cargo ship transports pipe sections (sometimes referred to as stands) to pipelay vessel 12. Crane 20 moves pipe sections from the cargo ship to pipelay vessel 12 onto cradles that form a conveyor system for moving pipe into production factory 16. Within production factory 16, a number of different operations are carried out to prepare and join pipe sections. For example, the pipe ends are beveled (and bevels are deburred). The pipe ends are preheated within production factory 16 and moved through a number of welding stations to join different sections with weld beads applied both to the outer and inner diameters of the sections at the joints. In some cases, a final welding station within production factory 16 applies a welded cap to the joints of pipe sections.

The joints of the welded pipe sections can also be tested within production factory 16. For example, the welded joints can pass through ultrasonic testing stations that apply water to the joints as the medium to transmit the ultrasonic signals. The ultrasonic signals can be processed by a computing system and graphically displayed for inspection by an operator.

After testing, the joints of the welded pipe sections can be grit blasted and a field joint coating can be applied. In some installation systems, each individual pipe is subjected to this process as it is welded to pipeline 14. In other cases, multiple pipes, e.g. two pipes in a double stand facility, are first welded together and then welded to the pipeline in the firing line onboard pipelay vessel 12. At any rate, the assembled pipeline 14 is ultimately conveyed through tensioners 18 and over stinger 22 to be dropped off of the stern of pipelay vessel 12 to sea floor 26.

As pipeline 14 is laid on sea floor 26, suspended pipe span 28 forms a shallow “S” shape between sea floor 26 and pipelay vessel 12. The “S” shape of suspended pipe 28 is sometimes referred to as the S-curve. Second curve 30 or the tail of the S-curve just before suspended pipe span 28 meets sea floor 26 is sometimes referred as the “sagbend.” The S-curve of pipeline 14 is controlled by stinger 22 and pipeline tensioners 18. Increases in the curvature of pipeline 14 cause increases in the bending moment on the pipeline, and, as a result, higher stresses. High stresses on pipeline 14 and, in particular, on suspended pipe span 28 can result in buckling of the pipeline 14. For example, a loss of tension in pipeline 14 during the pipe lay will normally cause pipeline 14 to buckle at a point along the suspended pipe span 28. A buckle in pipeline 14 is called a wet buckle if pipeline 14 has cracked or becomes damaged in a manner such that water is allowed to enter the inner diameter of the pipeline. The influx of water into the pipeline 14 greatly increases the weight of suspended pipe span 28 such that the pipe can become over stressed at a location along suspended pipe span 28, generally near stinger 22. In such circumstances, flooded pipeline 14 can break and drop from pipelay vessel 12 to sea floor 26. Regardless of whether pipeline 14 breaks in the event of a wet buckle, the increased weight can prevent recovery of and repair to pipeline 14 before the water is pumped out of the pipeline.

Examples according to this disclosure are directed to a wet buckle packer that can be deployed within the inner diameter of pipeline 14 as it is laid on sea floor 26. In FIG. 1, installation system 10 includes two wet buckle packers 32 and 34 deployed within pipeline 14. Packer 32 is deployed along suspended pipe span 28, while packer 34 is deployed downpipe where pipeline 14 meets sea floor 26. Wet buckle packers 32 and 34 are deployed within pipeline 14 with a hoist line or cable (not shown). In cases where multiple wet buckle packers are deployed in series, a hoist line may be coupled between the packers. In the example of FIG. 1, a hoist line may be coupled to a hoist on pipelay vessel 12 to packer 32 and another line can be coupled between packers 32 and 34. As will be apparent to persons skilled in the art, substantial benefits can be realized through an alternative configuration using only a single wet buckle packer, located generally in the position of depicted packer 34, positioned to prevent substantial inflow of water into the already-laid portion of pipeline 14 on sea floor 26.

Wet buckle packers 32 and 34 are configured to automatically respond to water invasion into the inner diameter of pipeline 14 and rapidly deploy a sealing system that will prevent the laid pipeline and pipeline above packer 32 from being flooded with sea water. For example, wet buckle packers 32 and 34 seal the inner diameter of pipeline 14 to prevent or significantly inhibit water from flooding the submerged pipeline. Additionally, wet buckle packers 32 and 34 deploy a braking mechanism to prevent or inhibit the packers from moving within pipeline 14 as a result of the pressures introduced by the sea water entering the pipe from the wet buckle.

In some cases one or more “piggy-back” lines may be laid from pipelay vessel 12 along with main pipeline 14. Piggy-back lines are generally constructed from smaller diameter pipes that are assembled in a similar manner as described above with reference to pipeline 14. The piggy-back lines are assembled in parallel with and are then coupled to pipeline 14, e.g., with a sleeve connected to top of the main pipeline 14 in which the piggy-back lines are received.

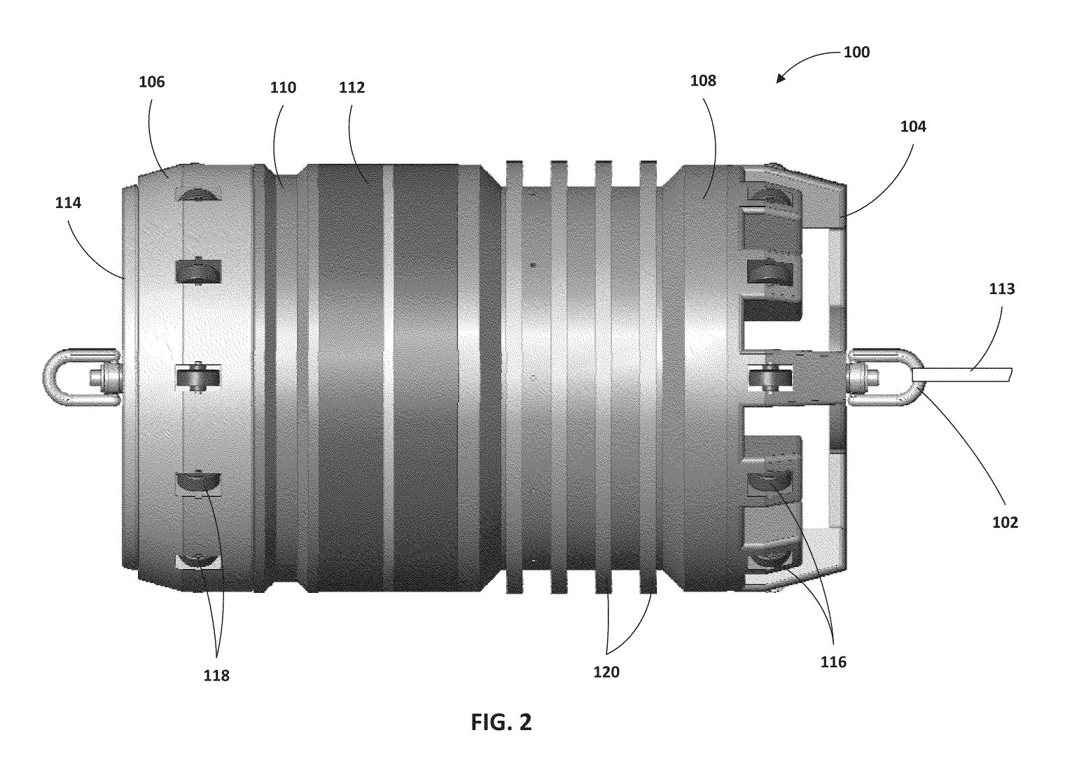

FIG. 2 depicts example wet buckle packer 100. Packer 100 includes a hoist ring 102, first and second end caps 104 and 106, first and second mandrels 108 and 110, and elastomeric expansion boot 112. Packer 100 also includes end plate 114, which is connected to second end cap 106. Packer 100 is coupled to hoist line 113 by hoist ring 102, which is connected to first end cap 104.

Packer 100 is configured to be deployed from a pipelay vessel down a submerged pipeline via hoist line 113. Packer 100 can be lowered into an already submerged pipeline or can be lowered along with a particular section of the pipeline as it is dropped to the sea floor. The generally cylindrical shape of packer 100 defined by the outer peripheries of end caps 104 and 106, first and second mandrels 108 and 110, and expansion boot 112 are configured to slide within the pipeline as packer 100 is deployed downpipe from the pipeline vessel. Additionally, first end cap 104 and second end cap 106 each include a number of freely rotating wheels 116 and 118, respectively, which are distributed around the outer circumference of each of the components. Wheels 116 and 118 facilitate travel of packer 100 through the submerged pipeline as packer 100 is lowered from the pipelay vessel and as otherwise may be needed during the pipe laying process. First mandrel 108 also includes a number of axially spaced, circumferential ribs 120. Ribs 120 can provide a number of functions including centralizing packer 100 within and guiding packer 100 through a pipeline during deployment or use.

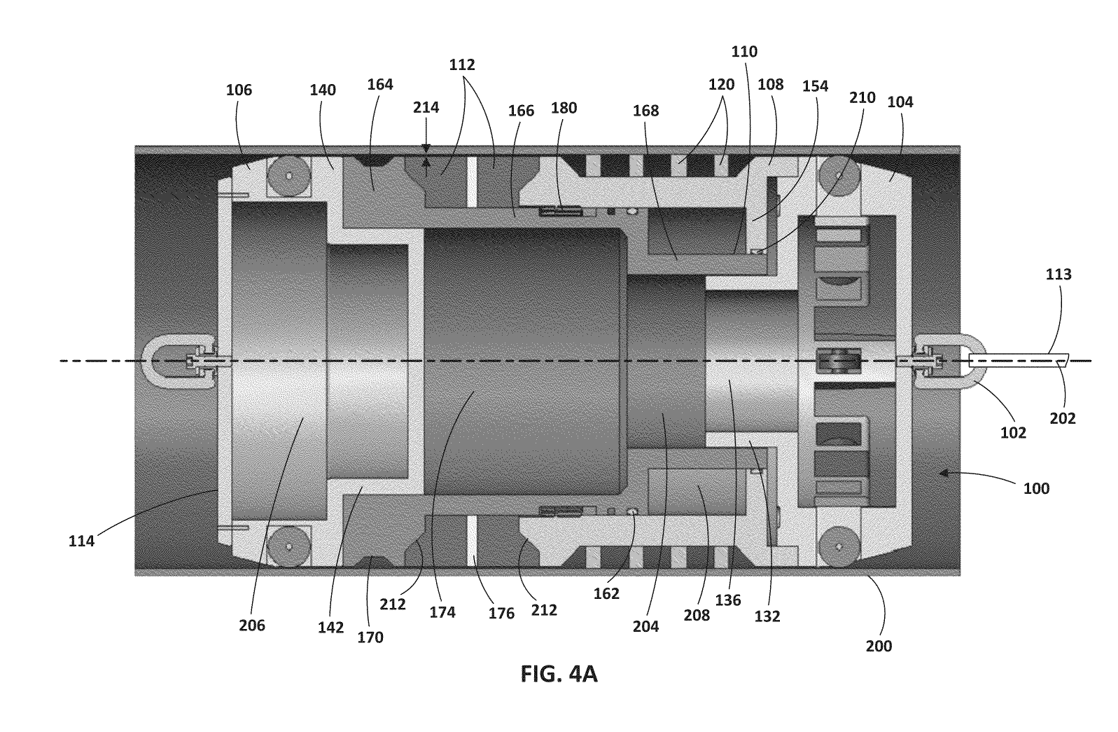

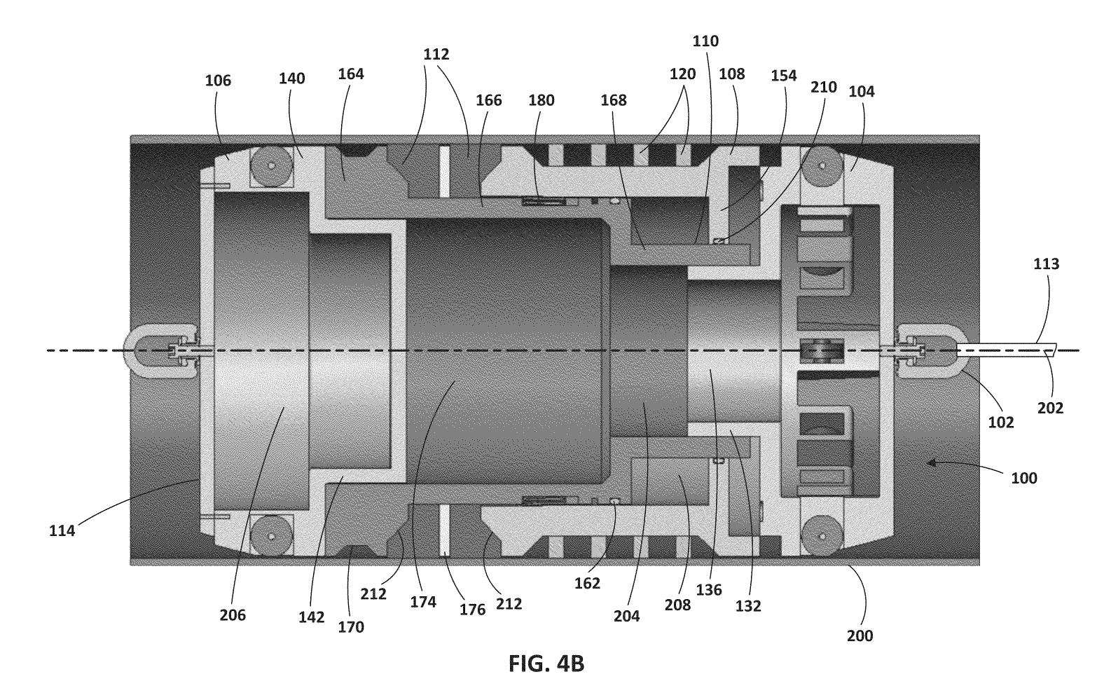

Packer 100 can be deployed at a number of locations within the submerged pipeline to arrest pipeline failures like wet buckles. For example, packer 100 can be deployed along a suspended pipe span of the pipeline or further downpipe where the pipeline meets the sea floor. Wet buckle packer 100 is configured to automatically respond to water invasion into the inner diameter of the pipeline and rapidly deploy a sealing system that will prevent the laid pipeline and pipeline above packer 32 from being flooded with sea water, which is described in more detail with reference to FIGS. 4A and 4B.

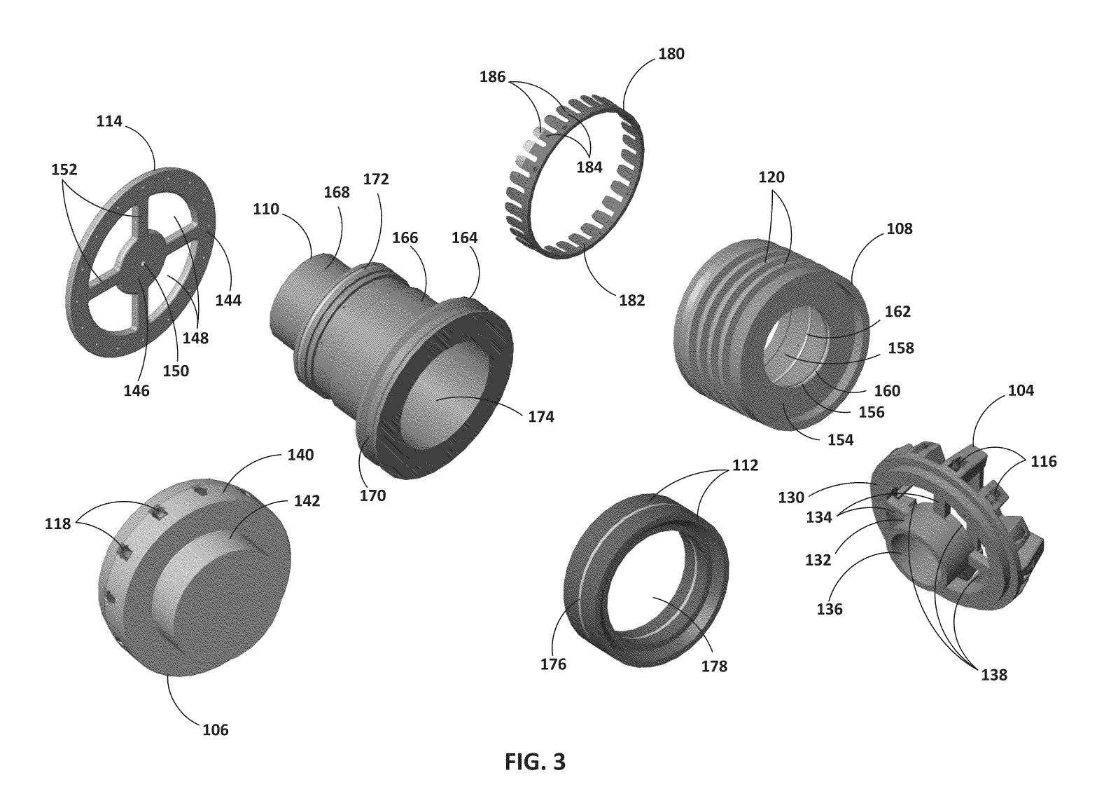

Hoist line 113 extends from hoist ring 102 up to, for example, a hoist machine on a pipelay vessel. In some examples, packer 100 can include hoist rings on both ends of the device to deploy multiple packers within a pipeline in spaced, series relation within the pipeline. In FIG. 3, packer 100 includes an additional hoist ring connected to end plate 114, which is connected to second end cap 106. Packer 100 is configured to be arranged within the pipeline such that the end including first end cap 104 faces the region of the pipeline that is at risk of a wet buckle (or other failure). Thus, in the example of FIG. 1, one packer could be deployed within suspended pipe span 28 closer to the surface than the likely location of the wet buckle in the sagbend of the “S” curve and another packer could be deployed within pipeline 14 on the other side of the likely wet buckle location, e.g., somewhere along sea floor 26.

In this example, the packer deployed closer to the surface would be arranged within suspended pipe span 28 such that first end cap 104 faces down toward the likely location of the wet buckle in the sagbend. This upper packer could include a hoist line running from the end of the device including second end cap 106 and another line running from perforated cap 104 to the lower packer. The lower packer closer to sea floor 26 would be arranged within the pipeline such that first end cap 104 faces up toward the likely location of the wet buckle in the sagbend and the lower packer would be connected to the upper packer by the line coupled to the first end caps of each device.

FIG. 3 depicts some components of packer 100 in an exploded view to illustrate the components in greater detail. First end cap 104 includes rim portion 130, hub portion 132, and spokes 134. Hub 132 is arranged at the center of first end cap 104 and spokes 134 extend radially outward from hub 132 to rim 130. Spokes 134 are offset from one another by approximately 90 degrees. Hub 132 includes central bore 136 and the spaces between spokes 134 define apertures 138.

Second end cap 106 includes cylindrical base 140 and shaft 142 extending radially from base 140. Wheels 118 are distributed around the circumference of base 140 of second end cap 106. End plate 114 is configured to be connected to base 140 of second end cap 106, e.g., by fasteners, welding, or another mechanism. End plate 114 includes rim portion 144, hub portion 146, and spokes 152. Hub 146 is arranged at the center of end plate 114 and spokes 152 extend radially outward from hub 146 to rim 144. Spokes 152 are offset from one another by approximately 90 degrees. Hub 146 includes central hole 150 and the spaces between spokes 134 define apertures 148. Central hole 150 in end plate 116 may receive a hoist ring for connecting a hoist line to the end of packer 100 including end plate 114 and second end cap 106.

First mandrel 108 is a generally cylindrical component with one end open and the other end partially closed and including rim 154 with central thru hole 156. Extending from the end of first mandrel 108 that is opposite rim 154 is central bore 158. Bore 158 extends from the end of first mandrel 108 and terminates at rim 154. The inner surface of central thru hole 156 can include groove 160, which can be configured to receive an O-ring or other appropriate sealing element. The surface of bore 158 also includes grooves, which can receive sealing elements such as, e.g., O-ring 162 configured to provide a seal between bore 158 of first mandrel 108 and a portion of second mandrel 110.

Second mandrel 110 includes a number of differently sized cylindrical portions. As illustrated in FIG. 3, second mandrel 110 includes a base 164, a middle 166, and an end 168 portion. Base 164 includes a generally “V” shaped groove 170. Middle portion 166 includes a number of grooves, one or more of which can be configured to receive sealing elements such as, e.g., O-ring 172 configured to provide a seal between middle portion 166 of second mandrel 110 and bore 158 of first mandrel 108. Second mandrel 110 also includes thru bore 174.

Expansion boot 112 includes two annular elastomeric boots separated by a spacer 176, about which boot 112 is substantially symmetrical. Expansion boot 112 includes central hole 178, through which middle portion 166 of second mandrel 110 is configured to be received.

Packer 100 also includes lock ring 180. Lock ring 180 is configured to lock packer 100 in an engaged state, as described in more detail below. Lock ring 180 includes ring 182 and tines 184. Ratchet teeth 186 are inscribed in the radially outer surface of each of tines 184.

FIGS. 4A and 4B depict section views of wet buckle packer 100 within pipeline 200. In FIG. 4A, packer 100 is unengaged with pipeline 200. In FIG. 4B, packer 100 is engaged with pipeline 200 to substantially seal the inner diameter of pipeline 200 from water invasion. As illustrated in the section views of FIGS. 4A and 4B, the components of packer 100 are axially aligned along longitudinal axis 202 of packer 100.

Second mandrel 110 is arranged between first end cap 104 and second end cap 106. Hub 132 of first end cap 104 is received in bore 204 through end portion 168 of second mandrel 110. Shaft 142 of second end cap 106 is received in bore 174 through base and end portions 164 and 166 of second mandrel 110. As illustrated in FIG. 4A, second end cap 106 is a hollow component that defines cavity 206 within base 140 and shaft 142.

First and second end caps 104 and 106 can be coupled to second mandrel 110 with a variety of mechanisms. In one example, hub 132 of first end cap 104 is press or interference fit with bore 204 of end portion 168 of second mandrel 110. Similarly, shaft 142 of second end cap 106 can be press or interference fit with bore 174 of second mandrel. In another example, hub 132 and shaft 142 can be threaded into bore 204 and bore 174, respectively.

First mandrel 108 is circumferentially disposed about and in axially moveable relation with second mandrel 110. Hole 156 in rim 154 of first mandrel 108 receives end portion 168 of second mandrel 110. Bore 158 of first mandrel 108 receives middle portion 166 of second mandrel 110. The space between rim 154, bore 158, and middle portion 166 forms cavity 208.

Expansion boot 112 includes two annular elastomeric boots separated by a spacer 176. Expansion boot 112 includes central hole 178, which receives middle portion 166 of second mandrel such that boot 112 is circumferentially disposed about middle portion 166. Expansion boot 112 is arranged between one end of first mandrel 108 and base portion 164 of second mandrel 110. First mandrel 108 is configured to move axially toward second mandrel 110 from a first position to a second position. As first mandrel 108 moves toward second mandrel 110, first mandrel 108 compresses expansion boot 112 axially. As expansion boot 112 is compressed axially, boot 112 also radially expands into engagement with an inner surface of pipeline 200.

Packer 100 is configured to be automatically actuated in the event of a wet buckle of pipeline 200. In such an event, water invades pipeline 200 and flows through the pipe toward first end cap 104. As noted, first mandrel 108 is configured to move axially toward second mandrel to engage packer 100. Without the application of an external force like the pressure produced by water in pipeline 200, first mandrel 108 is positioned closer to first end cap 104 to which hoist ring 102 is connected, as illustrated in FIG. 4A. When the wet buckle occurs, water invading pipeline 200 passes through apertures 138 (see FIG. 3) in first end cap 104 and strikes rim 154 of first mandrel 108. (The section view of FIGS. 4A and 4B are cut through spokes 134 of first mandrel 108 and, as such, apertures 138 are not visible in these figures.) The surface of rim 154 presents a relatively large surface area against which the water invading pipeline 200 can strike. The force of the water on rim 154 causes first mandrel 108 to move axially toward second mandrel 110. As first mandrel 108 moves toward second mandrel 110, hole 156 slides along end portion 168 and bore 158 slides along middle portion 166. The end of first mandrel 108 pushes expansion boot 112 against base portion 164 of second mandrel 110 to axially compress and radially expand boot 112 into engagement with the inner surface of pipeline 200, as illustrated in FIG. 4B.

As noted above, expansion boot 112 includes two annular elastomeric boots separated by a spacer 176. However, in other examples, expansion boot 112 can include 1 or more than two elastomeric elements. Spacer 176 can be a Teflon, brass, rubber, or other appropriate type of spacer element or elements interposed between the elastomeric boots of expansion boot 112. Employing multiple elastomeric boots allows each boot of expansion boot 112 to be formed of different durometer material. Employing multiple boots with multiple, different durometer elastomers can allow packer 100 to be used in a range of different depths and different temperatures.

The two elastomeric elements of expansion boot 112 include a non-linear edge profile on the edge of each boot opposite spacer 176. The shape of the edge of expansion boot 112, which is engaged by base portion 164 of second mandrel 110 and the end of first mandrel 108 may be configured to increase or assist the radial expansion of expansion boot 112. In particular, tapers 212 can function to improve the radial expansion of expansion boot 112, when boot 112 is compressed axially between first mandrel 108 and second mandrel 110.

Expansion boot 112 serves to both substantially seal pipeline 200 and to inhibit movement of packer 100 once the device has been engaged within the pipeline. In other words, packer apparatus in accordance with this disclosure include an elastomeric expansion boot that can be automatically actuated in response to and as a result of water invasion into a pipeline to both substantially seal and to inhibit the apparatus from moving within the pipeline. Although it may be included to augment the function of the boot, no additional or separate brake or slip mechanism is required to properly engage packer 100 (or another device in accordance with this disclosure) within pipeline 200.

In some cases, a principle of differential area can be employed to cause first mandrel 108 to move axially engage expansion boot 112. Ribs 120 can be designed to impede the flow of water but not to seal on the inner surface of pipeline 200. In some cases, therefore, it is assumed that water pressure will act on surfaces not protected by seals, including, e.g., the two ends of first mandrel 108. Water pressure is therefore assumed to be acting on the surface area of the end of first mandrel 108 that engages expansion boot 112 in addition to acting on the end of first mandrel 108 including rim 154. However, the surface area of the end of first mandrel 108 that engages expansion boot 112 is smaller than the surface area of the opposite end including rim 154. As such, even though the pressure may be balanced on both ends of first mandrel 108, the differential area causes the net force on first mandrel 108 to move first mandrel 108 toward the base portion 164 of second mandrel 110. This net force causes the first mandrel 108 to move towards second mandrel 110 to compress expansion boot 112 axially and expand boot 112 radially into engagement with pipeline 200.

In one example, the air in cavity 208 is at atmospheric pressure when packer 100 is in the unengaged state. The pressure in cavity 208 will increase when the packer is in the engaged state. However, packer 100 can be configured such that the increase in pressure in cavity 208 does not adversely affect engagement of the device.

The amount of force generated during actuation of packer 100 is a function of the water pressure inside pipeline 200 and also the surface areas of the end of first mandrel 108 that engages expansion boot 112 and the opposite end of first mandrel 108 including rim 154. To design packer 100 to withstand sufficient force to actuate the device without needing to withstand significant excess force during actuation, in some examples, rim 154 and the rest of the structure of first mandrel 108 can be fabricated as separate components that are configured to be connected when assembled into packer 100. Fabricating the rim separately can enable different rims with different amounts of surface area to be employed in the same or similar packer apparatus. In this manner, one or a small number of base packer apparatus can be configured to be deployed at different depths that will subject the devices to different water pressure levels by selecting the appropriate rim for each particular depth and expected water pressure.

In some examples, packer 100 can include an actuator that either augments the effect of the water pressure on rim 154 of first mandrel 108 or is employed in lieu of automatic actuation by the water pressure. For example, in the event the water pressure fails to actuate the device, packer 100 could include an actuator that drives first mandrel 108 to cause expansion boot 112 to engage pipeline 200. Example actuators that could be employed with packer 100 include a variety of mechanical and electromechanical devices that are configured to be actuated to drive first mandrel 108. For example, the actuator can include a pneumatically or hydraulically actuated piston that drives first mandrel 108 with air or a hydraulic fluid supplied by a supply line connected to packer 100. In another example, the actuator includes an electrically activated solenoid that drives first mandrel 108. In another example, the actuator includes an electromagnetic piston that drives first mandrel 108 based on controlled electricity transmitted to packer 100 via the supply line.

In another example, a plurality of springs can be arranged between first end cap 104 and first mandrel 108. A plurality of shear pins can be arranged through radially aligned apertures (not shown here) in first mandrel 108 disposed at different angularly disposed, circumferential positions around a longitudinal axis of packer 100. The shear pins can engage grooves in middle portion 166 of second mandrel 110 between O-ring 162 and lock ring 180. In such an example, the force generated by the water pressure will shear the pins and the spring force will augment the force generated by the water pressure to engage packer 100 within pipeline 200.

In some examples, packer 100 can include a sensor system that detects the invasion of water into the inner diameter of pipeline 200. In another example, the sensor system can be associated with a separate component and be communicatively coupled to packer 100. In one example, the sensor system includes a water sensor including two spaced electrodes arranged within pipeline 200 such that water invading the pipeline would complete an electrical circuit of the sensor. In another example, a pressure sensor could be used to detect the invasion of water into the inner diameter of pipeline 118. The sensor system communicatively coupled to packer 100 can provide a signal directly to control electronics included in an actuator of packer 100 or can transmit signals to a surface system, which, in turn, transmits control signals to an actuator via a supply line. Wet buckle detection via such a sensor system could be employed to test or verify whether packer 100 is actuated and, in some examples, could be used as a trigger to activate an actuator included in packer 100.

Packer 100 is configured such that in the unengaged state illustrated in FIG. 4A at least some portions of the outer boundaries of packer 100 are offset from the inner surface of pipeline 200. The offset distance between packer 100 and the inner surface of pipeline 200 may differ at different points along the axial length of packer 100. For example, offset 214 between expansion boot 112 and the inner surface of the pipeline 200 is different than the offset between other components of packer 100 and the inner surface of pipeline 200. In one example, packer 100 is designed such that offset 214 is less than or equal to ⅛ inch, while the offset between unengaged components of packer 100 and pipeline 200 is greater than ⅛ inch. However, in other examples, offset 214 can be larger or smaller depending on the clearance between packer 100 and pipeline 200 necessary to allow packer 100 to be deployed through pipeline 200 and the amount of radial expansion of expansion boot 112 and brake pads 168 that is provided when spindle 106 moves axially toward base cap 108.

Although particular offset distances are described with reference to example packer 100, a packer in accordance with this disclosure will be constructed with a desired dimensional relationship with the dimensions of the pipeline in which the device is to be used. In one example configuration, a radial clearance of less than or approximately equal to ⅛ inch will separate the sealing and braking elements of the packer and the pipeline inner surface and a radial clearance of less than or approximately equal to ¼ inch will separate unengaged components of the packer and the pipeline inner surface. However, as will be apparent to persons skilled in the art, difference radial dimensions may be used for any size pipe, and in some cases such dimensions may be determined by other factors, such as the designed radius of bends the pipeline will experience while being installed on the sea floor, and/or the intended characteristic of the internal welds used to join the pipeline sections.

In some cases, it may be desirable to configure packer 100 such that offset 214 between expansion boot 112 and the inner surface of the pipeline 200 is as small as possible while still allowing packer 100 to be deployed downpipe within pipeline 200. In one example, the outer periphery of expansion boot 112 is configured to abut or nearly abut the inner surface of pipeline 200 even in the unengaged state of packer 100, as illustrated in FIG. 4A. In practice, there may be a delay between the occurrence of a wet buckle to pipeline 200 and water striking rim 154 of first mandrel 108 to cause packer 100 to become engaged with the inner surface of pipeline 200. During the delay in actuation of packer 100 some water may pass through packer 100. Reducing offset 214 between expansion boot 112 and the inner surface of the pipeline 200 will reduce the amount of water that floods pipeline 200 before packer 100 is engaged and expansion boot 112 substantially seals the inner diameter of the pipeline. Additionally, to further reduce water flow by packer 100, the outer periphery of first and second end caps 104 and 106 and first and second mandrels 108 and 110 may also be configured to fit closely with the inner surface of pipeline 200.

As noted above, first mandrel 108 includes ribs 120. In addition to centralizing and guiding packer 100 within pipeline 200, ribs 120 may also serve to reduce the amount of water that passes packer 100 within pipeline 200 as packer 100 is engaged in response to a wet buckle. As such, the offset between ribs 120 and pipeline 200 can be equal to, or, in some cases, less than offset 214 between expansion boot 112 and pipeline 200.

As is illustrated in FIGS. 4A and 4B, first and second end caps 104 and 106, and first and second mandrels 108 and 110 are hollow, relatively thin-walled components. It may be desirable to design the components of packer 100 and other wet buckle packers in accordance with this disclosure in order to reduce the weight of the device. Packer 100 may be employed in relatively large pipelines. In one example, pipeline 200 has an inner diameter that is approximately equal to 40 inches. The large size of pipeline 200 necessitates a relatively large packer to seal the inner diameter of the pipeline. As such, in one example, packer 100 may weigh on the order of thousands of pounds. In such situations, removing as much material from first and second end caps 104 and 106, and first and second mandrels 108 and 110 can have a significant impact on the weight of packer 100.

The overall weight of packer 100 also affects the amount of load on hoist line 113 and, as a result, the amount of work required by the hoist machine operating hoist line 113. As such, reducing the weight of packer 100 can also reduce the cost and complexity of deploying packer 100 via hoist line 113.

The forces encountered by packer 100 in the event of a wet buckle of pipeline 200 may be significant. For example, at a relatively shallow depth of approximately 1500 feet below sea level, the pressures generated by a wet buckle can reach approximately 660 pounds per square inch (psi). At a depth of approximately 12,000 feet, the pressures generated by a wet buckle can reach approximately 5280 psi. In view of the range of forces potentially encountered by wet buckle packer 100, the wall thicknesses of the components of packer 100 may need to be adjusted to withstand large forces/pressures.

Forces encountered by different portions of packer 100 may differ significantly. For example, portions of packer 100 may be partially or substantially pressure balanced because water introduced into pipeline 200 is allowed to enter parts of packer 100. In such situations, the pressure of the water is balanced on particular portions of packer 100. For example, water may be allowed to enter portions of packer 100 such that the water pressure is balanced on either side of a wall of one or more of first and second end caps 104 and 106, and first and second mandrels 108 and 110. For example, in the event of a wet buckle, packer 100 can be configured to allow some water flow past the device within pipeline 200. Water may pass through apertures 116 in first end cap 104 and enter bores 208 and 174 in second mandrel. Additionally, water may flow through apertures 148 in end plate 114 into cavity 206 in second end cap 108. Cavity 208, on the other hand, can be configured to remain substantially sealed against water invasion to maintain the cavity with atmospheric air, as described above. In some examples, therefore, packer 100 may be designed to allow pressure balancing of some portions of the device such that the wall thicknesses of different portions of first and second end caps 104 and 106, and first and second mandrels 108 and 110 of packer 100 may differ significantly depending on the amount of pressure/force encountered in the event of a wet buckle.

A variety of materials can be used to fabricate the components of packer 100 including, e.g., metals, plastics, elastomers, and composites. For example, first and second end caps 104 and 106, and first and second mandrels 108 and 110 can be fabricated from a variety of different types of steel or aluminum. Expansion boot 112, however, can be fabricated from a variety of elastomeric materials including rubber. Additionally, in one example, ribs 120 are fabricated from a different material than the rest of first mandrel 108. For example, first mandrel 108 may be fabricated from a rigid material such as steel or aluminum, while ribs 120 are fabricated from an elastomer such as polyurethane. In one example, expansion boot 112 and/or ribs 120 are fabricated from a nitrile rubber. At the sea floor, packer 100 may encounter temperatures as low as 32 degrees Fahrenheit (0 degrees Celsius). As such, expansion boot 112 and/or ribs 120 may need to be fabricated from elastomers that can withstand relatively low temperatures without significantly affecting the material properties of the components. For example, expansion boot 112 may need to be fabricated from elastomers that can withstand relatively low temperatures without causing boot 112 to become too hard, stiff and/or brittle such that the disks are incapable of sufficiently sealing the inner diameter of pipeline 200. The components of packer 100 can be fabricated using a variety of techniques including, e.g., machining, injection molding, casting, and other appropriate techniques for manufacturing such parts.

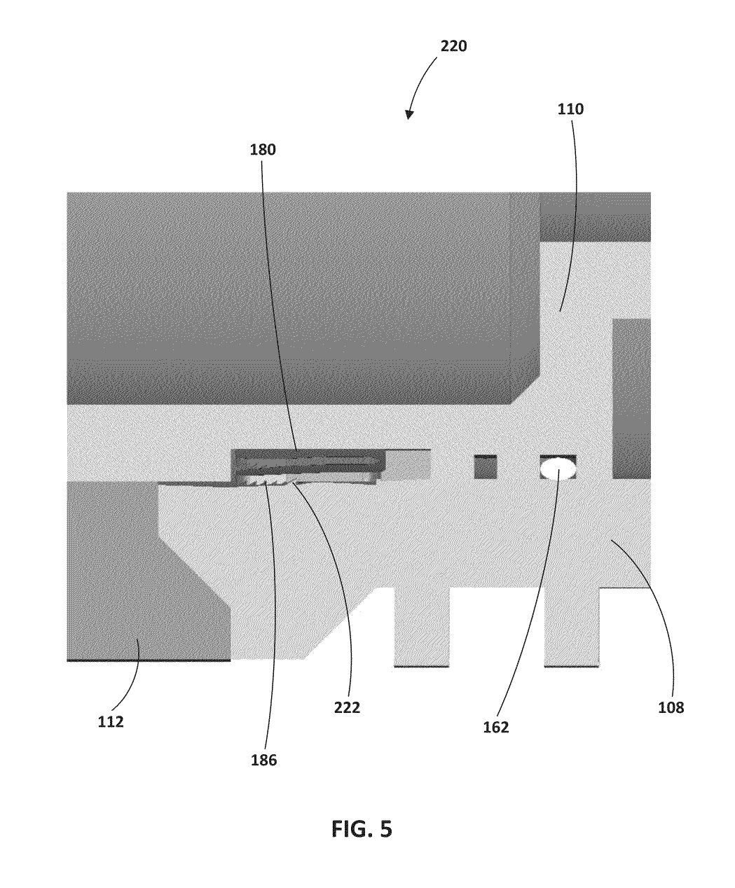

Packer 100 also includes a locking mechanism including lock ring 180 and ratchet teeth 222 inscribed in a portion of the inner surface of bore 158 of first mandrel 108. FIG. 5 depicts a detail view of locking mechanism 220 including lock ring 180 and ratchet teeth 222. Locking mechanism 220 is configured to lock packer 100 in engagement with the inner surface of pipeline 170.

Locking mechanism 200 includes lock ring 180 and ratchet teeth 222. Lock ring 180 is circumferentially disposed around middle portion 166 of second mandrel 110 within bore 158 of first mandrel 108. Lock ring includes axially extending tines 184, each of which includes ratchet teeth 186. As first mandrel 108 moves axially toward second mandrel 110, the tapered surfaces of ratchet teeth 222 in first mandrel 108 cause teeth 186 on lock ring 180 to be pushed outward to allow first mandrel 108 to move in one direction one row of teeth 186 at a time. When expansion boot 112 has been radially expanded into engagement with pipeline 200 by the movement of first mandrel 108, the blocking surfaces of teeth 186 of lock ring 180 and teeth 222 of first mandrel prevent first mandrel 108 from moving away from second mandrel 110. In this manner, locking mechanism 220 locks packer 100 into engagement against the inner surface of pipeline 200.

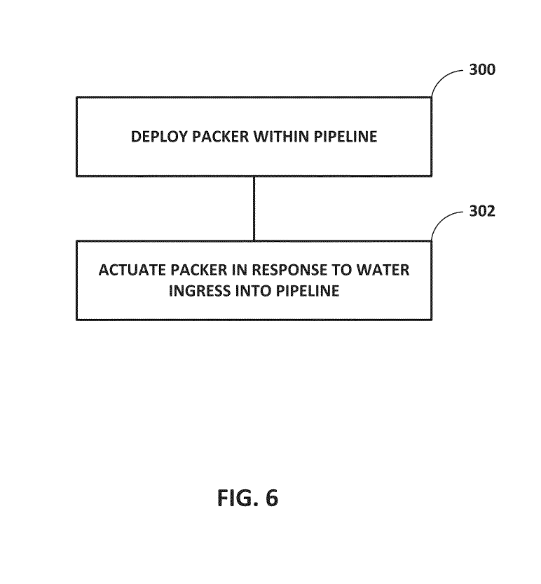

FIG. 6 is a flowchart depicting an example method of arresting a failure of a submerged pipeline. The method includes deploying a packer apparatus within the pipeline (300) and actuating the packer apparatus in response to water ingress into the pipeline (302). The packer apparatus can be deployed into the pipeline via a hoist line connected to a hoist machine on a pipelay vessel. In one example, the packer apparatus that is employed in conjunction with the example method of FIG. 6 is similar to packer 100 described above. As such, in one example, packer 100 employed to carry out the method of FIG. 6 includes first and second mandrels 108 and 110 coupled in selectively axial moveable relation to one another, and elastomeric expansion boot 112 circumferentially disposed around a portion of second mandrel 110. First mandrel 108 is responsive to fluid flow in the pipeline to move axially toward second mandrel 110 from a first position to a second position. In the second position, expansion boot 112 is compressed axially between first and second mandrels 108 and 110 and expanded radially into engagement with an inner surface of the pipeline.

Packer 100 is actuated in response to and as a result of water ingress into the pipeline. For example, actuating packer 100 can include moving first mandrel 108 axially toward second mandrel 110 from a first position to a second position. First mandrel 108 is moved from the first to the second position as a result of fluid pressure generated by the water in the pipeline. The fluid pressure of the water in the pipeline acts to push rim 154 of first mandrel 108, which drives first mandrel 108 axially toward second mandrel 110. In the second position, one end of first mandrel 108 engages one side of expansion boot 112 and base portion 164 of second mandrel 110 engages the opposite side of expansion boot 112 to axially compress and radially expand expansion boot 112 into engagement with the inner surface of the pipeline.

As described above, methods of arresting failures of a submerged pipeline can include deploying multiple packers within the submerged pipeline. In one example, the packers are deployed on either side (e.g. one closer to the surface and one farther from the surface and closer to the sea floor) of the likely location of the wet buckle (or other failure). In such examples, both packers can be actuated to seal the region of the pipeline between the packers and including the location of the failure.

The method of FIG. 6 includes actuation of a packer apparatus in response to and as a result of water ingress into a pipeline. As illustrated by the examples of packer 100, the packer can not only be actuated in response to but also as a result of the water the water in the pipeline. In other words, the packer actuation is automatically caused by fluid pressure generated by the water invading the pipeline. Thus, the example method of FIG. 6 can be carried out with any packer apparatus that is configured to be automatically actuated by fluid pressure within a pipeline. Additional examples of such apparatus are disclosed and described in U.S. application Ser. No. ______ (Atty. Docket No. 1880.517US1), filed on July ______, 2013, U.S. application Ser. No. ______ (Atty. Docket No. 1880.519US1), filed on July ______, 2013, and U.S. application Ser. No. ______ (Atty. Docket No. 1880.523US1), filed on July ______, 2013, all of which are entitled “METHODS AND APPARATUS FOR ARRESTING FAILURES IN SUBMERGED PIPELINES,” and the entire contents of all of which are incorporated herein by reference.

Various examples have been described. These and other examples are within the scope of the following claims.

I claim:

1. A packer apparatus configured to be arranged within and arrest a failure of a submerged pipeline, the packer apparatus comprising:
first and second mandrels coupled in selectively axial moveable relation to one another; and
an elastomeric expansion boot circumferentially disposed around a portion of the second mandrel,
wherein the first mandrel is responsive to fluid flow in the pipeline to move axially toward the second mandrel from a first position to a second position, and wherein, in the second position, the expansion boot is compressed axially between the first and second mandrels and expanded radially into engagement with an inner surface of the pipeline.

2. The apparatus of claim 1, further comprising an end cap connected to the first mandrel, and wherein the end cap comprises apertures arranged to allow a fluid to flow through the end cap and engage the first mandrel to move the first mandrel axially toward the second mandrel from the first position to the second position.

3. The apparatus of claim 2, wherein the end cap comprises a first end cap, and further comprising a second end cap connected to the second mandrel, and wherein the first end cap defines a first end of the packer apparatus and the second end cap defines a second end of the packer apparatus.

4. The apparatus of claim 3, wherein at least one of the first end cap and the second end cap comprises a plurality of wheels rotatably connected to the at least one of the first end cap and the second end cap.

5. The apparatus of claim 1, wherein, in the first position of the first mandrel, the expansion boot is in a radially unexpanded state and is unengaged with the inner surface of the pipeline.

6. The apparatus of claim 1, wherein:
the second mandrel comprises a first cylindrical portion comprising a first diameter and a second cylindrical portion comprising a second diameter that is smaller than the first diameter;
the first mandrel comprises:
a bore extending from a first end toward a second end of the first mandrel; and
a rim and central thru hole adjacent the second end; and
the bore of the first mandrel receives at least a portion of the second cylindrical portion of the second mandrel.

7. The apparatus of claim 6, wherein the expansion boot is circumferentially disposed around the second cylindrical portion between the first cylindrical portion and the first end of the first mandrel.

8. The apparatus of claim 7, wherein:
the expansion boot comprises a first surface configured to be engaged by the first end of the first mandrel and a second surface configured to be engaged by the second cylindrical portion of the first mandrel;
at least a portion of the first surface comprises a first taper that matches a second taper of the first end of the first mandrel; and
at least a portion of the second surface comprises a third taper that matches a fourth taper of the second cylindrical portion of the second mandrel.

9. The apparatus of claim 8, wherein the expansion boot comprises two elastomeric expansion boots separated by a spacer.

10. The apparatus of claim 9, wherein a first of the two elastomeric expansion boots comprises the first surface and a second of the two elastomeric expansion boots comprises the second surface.

11. The apparatus of claim 1, further comprising a locking mechanism configured to lock the first mandrel in the second position.

12. The apparatus of claim 11, wherein the locking mechanism comprises:
a lock ring comprising a plurality of axially extending tines, wherein each of the tines comprises a plurality of ratchet teeth; and
at least one ratchet tooth inscribed an inner surface of the first mandrel,
wherein the at least one ratchet tooth inscribed the inner surface of the first mandrel is configured to engage at least one of the ratchet teeth of the tines of the lock ring to lock the first mandrel in the second position.

13. A system for arresting a failure of a submerged pipeline, the system comprising:
a hoist machine;
a packer apparatus configured to be arranged within the submerged pipeline, wherein the packer apparatus comprises:
first and second mandrels coupled in selectively axial moveable relation to one another; and
an elastomeric expansion boot circumferentially disposed around a portion of the second mandrel,
wherein the first mandrel is responsive to fluid flow in the pipeline to move axially toward the second mandrel from a first position to a second position, and wherein, in the second position, the expansion boot is compressed axially between the first and second mandrels and expanded radially into engagement with an inner surface of the pipeline; and
a hoist line comprising a first end operatively connected to the hoist machine and a second end connected to the packer apparatus.

14. The system of claim 13, wherein the packer apparatus comprises an end cap connected to the first mandrel, and wherein the end cap comprises apertures arranged to allow a fluid to flow through the end cap and engage the first mandrel to move the first mandrel axially toward the second mandrel from the first position to the second position.

15. The system of claim 14, wherein:
the end cap comprises a first end cap;
the packer apparatus comprises a second end cap connected to the second mandrel; and
the first end cap defines a first end of the packer apparatus and the second end cap defines a second end of the packer apparatus.

16. The system of claim 15, wherein at least one of the first end cap and the second end cap comprises a plurality of wheels rotatably connected to the at least one of the first end cap and the second end cap.

17. The system of claim 13, wherein, in the first position of the first mandrel, the expansion boot is in a radially unexpanded state and the brake is unengaged with the inner surface of the pipeline.

18. The system of claim 13, wherein:
the second mandrel comprises a first cylindrical portion comprising a first diameter and a second cylindrical portion comprising a second diameter that is smaller than the first diameter;
the first mandrel comprises:
a bore extending from a first end toward a second end of the first mandrel; and
a rim and central thru hole adjacent the second end; and
the bore of the first mandrel receives at least a portion of the second cylindrical portion of the second mandrel.

19. The system of claim 18, wherein the expansion boot is circumferentially disposed around the second cylindrical portion between the first cylindrical portion and the first end of the first mandrel.

20. The system of claim 18, wherein:
the expansion boot comprises a first surface configured to be engaged by the first end of the first mandrel and a second surface configured to be engaged by the second cylindrical portion of the first mandrel;
at least a portion of the first surface comprises a first taper that matches a second taper of the first end of the first mandrel; and
at least a portion of the second surface comprises a third taper that matches a fourth taper of the second cylindrical portion of the second mandrel.

21. The system of claim 20, wherein the expansion boot comprises two elastomeric expansion boots separated by a spacer.

22. The system of claim 21, wherein a first of the two elastomeric expansion boots comprises the first surface and a second of the two elastomeric expansion boots comprises the second surface.

23. The system of claim 13, wherein the packer apparatus comprises a locking mechanism configured to lock the first mandrel in the second position.

24. The system of claim 23, wherein the locking mechanism comprises:
a lock ring comprising a plurality of axially extending tines, wherein each of the tines comprises a plurality of ratchet teeth; and
at least one ratchet tooth inscribed an inner surface of the first mandrel,
wherein the at least one ratchet tooth inscribed the inner surface of the first mandrel is configured to engage at least one of the ratchet teeth of the tines of the lock ring to lock the first mandrel in the second position.

25. A system for arresting a failure of a submerged pipeline, the system comprising:
a first packer apparatus configured to be disposed at a first position within the pipeline; and
a second packer apparatus configured to be disposed at a second position within the pipeline,
wherein at least one of the first and the second packer apparatus comprises:
first and second mandrels coupled in selectively axial moveable relation to one another; and
an elastomeric expansion boot circumferentially disposed around a portion of the second mandrel,
wherein the first mandrel is responsive to fluid flow in the pipeline to move axially toward the second mandrel from a first position to a second position, and wherein, in the second position, the expansion boot is compressed axially between the first and second mandrels and expanded radially into engagement with an inner surface of the pipeline.

26. A method of arresting a failure of a submerged pipeline, the method comprising:
deploying a packer apparatus within the pipeline, wherein the packer apparatus comprises:
first and second mandrels coupled in selectively axial moveable relation to one another; and
an elastomeric expansion boot circumferentially disposed around a portion of the second mandrel,
actuating the packer apparatus in response to water ingress into the pipeline,
wherein actuating the packer apparatus comprises moving the first mandrel axially toward the second mandrel from a first position to a second position, and
wherein, in the second position:
the expansion boot is compressed axially between the first and second mandrels and expanded radially into engagement with an inner surface of the pipeline.
